(19) United States
(12) Patent Application Publication
(10) Pub. No.: US 2012/0222451 A1
(43) Pub. Date: Sep. 6, 2012

(54) Shaping of Replaceable Elements of a Melting Furnace

(76) Inventor: Uwe Geib, Penzberg (DE)

(21) Appl. No.: 13/408,777

(22) Filed: Feb. 29, 2012

Related U.S. Application Data
(63) Continuation of application No. PCT/EP2010/005314, filed on Aug. 30, 2010.

(30) Foreign Application Priority Data
Sep. 3, 2009 (DE) 10 2009 040 033.8

(51) Int. Cl. C03B 7/01

(52) U.S. Cl. 65/125; 65/324

(57) ABSTRACT

Methods and apparatus for the extension of a furnace campaign and/or the reduction of energy input during melting by the shape of exchangeable component assemblies surrounding the melt which are located in the area of the melt surface and which are in contact with the transition area, below as well as above of the melt surface. The same holds for the haulage way of the melt.

### CROSS-REFERENCE TO RELATED APPLICATIONS

The present application is a continuation of PCT Application No. PCT/EP2010/005314 filed by the present inventor on Aug. 30, 2010.

The aforementioned PCT patent application is hereby incorporated by reference in its entirety.

### BACKGROUND OF THE INVENTION

1. Field of the Invention

The invention relates to methods and apparatus for the extension of a furnace campaign and/or the reduction of energy input during melting by the shape of exchangeable component assemblies surrounding the melt which are located in the area of the melt surface and which are in contact with the transition area, below as well as above of the melt surface. The same holds for the haulage way of the melt.

2. Brief Description of the Related Art

Such a melting furnace is, within others, known from the patent application DE10 2008 050855, also published as WO 2010/040486.

Known components in the area of the melt surface, in particular of glass, are made in form of a soldier course in order to avoid horizontal joints or gaps. In particular, in the area of flux lines there is a strong detrition (erosion, corrosion).

It is an object of the invention to extend the furnace campaign and/or to reduce the energy input during melting by forming the components that are used therefore and which are located in the transition area of the melting surface and which contact the transition area below as well as above of the melt surface, via shaping such that the elements that are exchangeable during the melting operation have a secure guide with the carrier elements that are not exchangeable during the melting operation, a secure sealing of the melt is ensured and, if possible, a cost effective manufacture. The same also holds for haulage ways or extraction drifts of the melt.

### SUMMARY THE INVENTION

The present disclosure relates to an apparatus and a method for ensuring a secure sealing of the melting furnace or the haulage track/extraction drift of the melt, a secure guide and support for the elements which are exchangeable during the melting operation, such that the elements which are exchangeable during the melting operation enable an improvement in relation to the furnace campaign and/or a reduction of the energy input during melting. The same holds for haulage tracks/extraction drifts of the melt. This is achieved by the arranging the main guide or guideway and the main resting surface of the elements which are exchangeable during the melting operation above the melt surface. This ensures that the elements which are exchangeable during the melting operation have a secure support in the long range and a secure guidance with the carrier elements in the long range.

The main guideway (5) is the guide which has a secure support such as for example preventing a sliding of the elements (3) which are exchangeable during the melting operation into the melt (1) and which have a prolonged durability with respect to the secondary guide (6).

In contrast to that, the secondary guideway (6) is the guide which has either a rather negligible guide with respect to the main guideway (5) and/or a shorter durability with respect to the main guideway (5). A secondary guideway (6) is not required therein as well as a plurality of secondary guidance (6) can exist.

The main guideway (5) can also be composed of a plurality of main guides (5).

The main resting surface (7) is the surface on which the elements (3) which are exchangeable during the melting operation mainly rest on the support elements (4) and/or that have a prolonged durability with respect to the secondary resting surface (8). In contrast to that, the secondary resting surface (8) is the surface which either only supports a reduced load with respect to the main resting surface (7), that the elements (3) which are exchangeable during the melting operation exercise on the support elements (4) and/or a reduced durability with respect to the main resting surface (7). A secondary resting surface (8) is not required therein as well as a plurality of secondary resting surfaces (8) may exist.

The main resting surface (7) can also be composed of a plurality of main resting surfaces (7).

The guide and the support surface of the element (3) which is exchangeable during the melting operation can also form a combined unit with the support element (4). This can be achieved, for example by an inflection point.

A main inflection point (9) is the inflection point or breakpoint, in FIG. 1 to FIG. 3 in direction of the Y-axis, which is located above the melt surface (2) and which forms a main support surface (7) at least by a parallel course with respect to the melt surface (2), as shown in FIG. 3, while a course descending in direction of the Y-axis towards the melt surface (2), as shown in FIG. 2 can form a main guideway (5) and/or a main resting surface (7), or a unit made thereof, by which a prolonged durability of the main inflection point (9) with respect to the secondary inflection point (10) of the element (3) which is exchangeable during the melting operation is ensured with respect to the secondary inflection point (10) which is located below the melt surface (2).

The descending course, as shown in FIG. 2, of the surface guiding away from the melt (1) at the element (3) which is exchangeable during the melting operation, the main inflection point (9) which descends in the direction of the Y-axis towards the melt surface (2), can herein again be located below the melt surface (2), because the main inflection point (9) above the melt surface (2) prevents the inflow of the melt (1) into the guideway and/or support.

A secondary inflection point (10) is not required herein, as well as a plurality of secondary inflection points (10) can exist.

The main inflection point (9) can also be composed of a plurality of main inflection points (9).

The guideway and the support surface of the element (3) which is exchangeable during the melting operation can also form a combined unit by at least one main inflection point (9), as shown in FIG. 2.

A secure distance of the guideway and/or the support surface with respect to the melt surface (2) provides a long-term guide and/or rest for the support elements (4).

### BRIEF DESCRIPTION OF THE DRAWINGS

For a more complete understanding of the present invention and the advantages thereof, reference is now made to the following description and the accompanying drawings, in which:

FIG. 1 is a cross section through a portion of a possible design, through the melting furnace or through the haulage track of the melt (1) with melt surface (2), the element (3) which is exchangeable during the melting operation, and the support element (4). With illustration of the combined main guideway (5) and main resting surface (7) of the element (3) which is exchangeable during the melting operation, in a combined unit.

FIG. 2 is a cross section through a portion of a possible design, trough the melting surface or through the haulage track of the melt (1), with melt surface (2), the element (3) which is exchangeable during the melting operation, and the support element (4). With shaping the carrier element (4) by sawing the shape of the element (3) which is exchangeable during the melting operation.

FIG. 3 is a cross section through a portion of a possible embodiment, through the melting furnace or though the haulage track of the melt (1), with melt surface (2), the element (3) which is exchangeable during the melting operation, and the support element (4). With illustration of the combined main guideway (5) and the main resting surface (7) of the element (3) which is exchangeable during the melting operation in a combined unit, a second main resting surface (7) and a secondary resting surface (8) below the melt surface (2).

### DETAILED DESCRIPTION

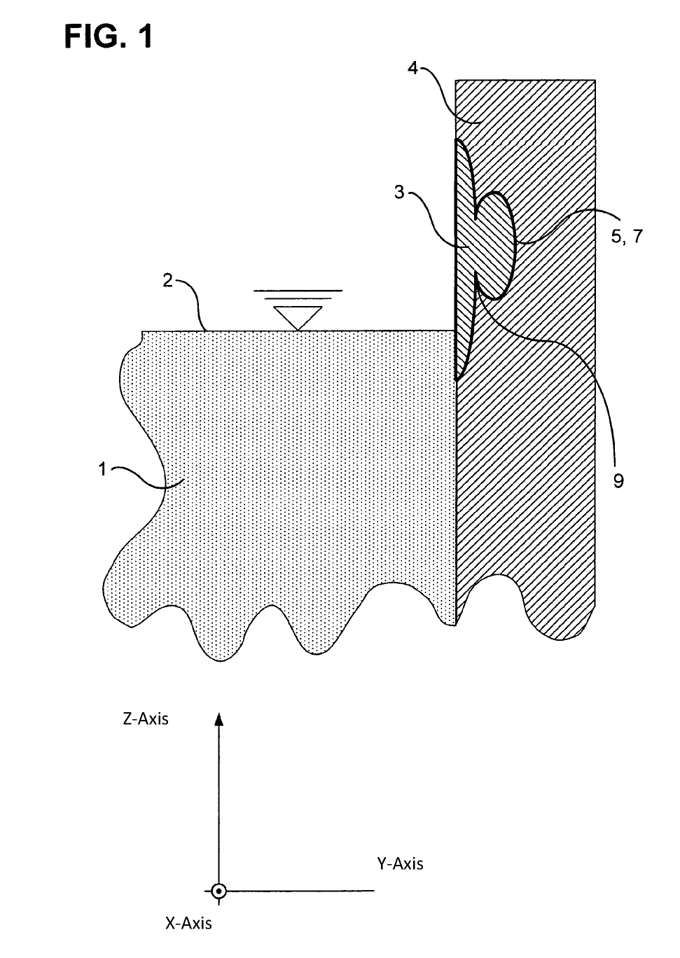

FIG. 1 shows a method and an apparatus according to a preferred embodiment of the present invention as a cross section through of a portion of a melting furnace or a haulage track with a coordinate system in the Y-axis and Z-axis, formed such that the main guideway (5) and the main resting surface (7) are combined in one unit. This unit, formed as an elliptical shape in a cross section, and placed on top of a sub element with elliptical shape in a cross section, form together the element (3) which is exchangeable during the melting operation. The main inflection point (9) of the element (3) which is exchangeable during the melting operation is arranged above the melt surface (2), wherein the main guideway (5) and the main resting surface (7) are also arranged above the melt surface (2). This ensures that the guide and/or support of the element (3), which is exchangeable during the melting operation with the carrier element (4), remains in operation for a long period in time.

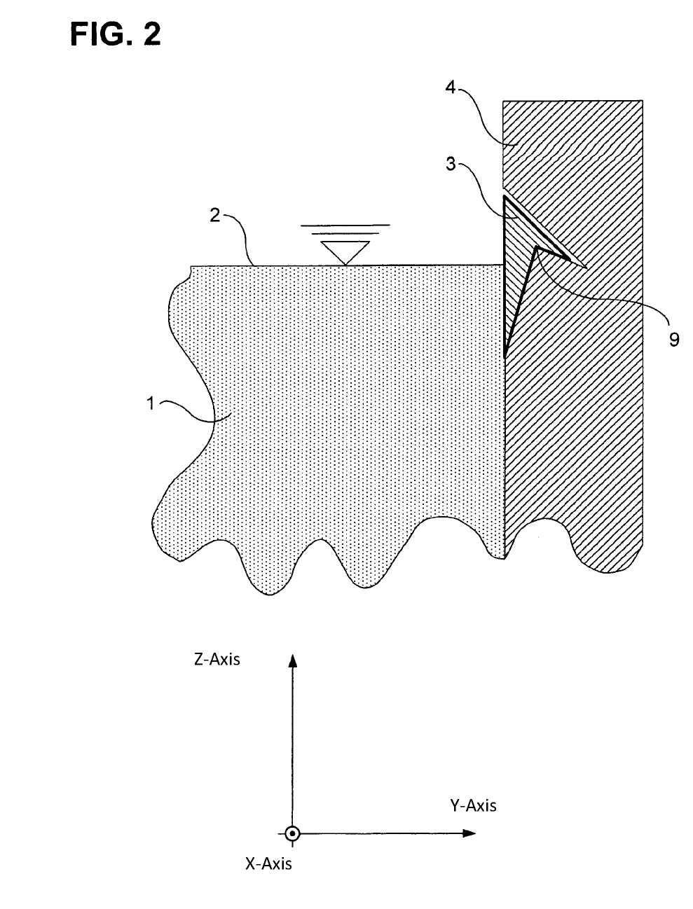

FIG. 2 shows a method and apparatus according to a preferred embodiment of the present invention in a cross section through of a portion of a melting furnace or a haulage track with the coordinate system in the Y-axis and the Z-axis, formed such that for example existing DIN-shapes can be used for the manufacture of the non-exchangeable carrier element (4) and the cutout in the carrier element (4) can be obtained by shaping of the element (3) which is exchangeable during the melting operation in a simple way by sawing. The element (3) which is exchangeable during the melting operation can also be obtained by sawing of a DIN-element. The main inflection point (9) of the element (3) which is exchangeable during the melting operation is arranged above the melt surface (2) and provides the main guideway (5) and the main resting surface (7) and prevents thereby the introduction of the melt into the main guideway (5) by which ensure serviceability of the element (3) which can be exchanged during the melting operation in the long range.

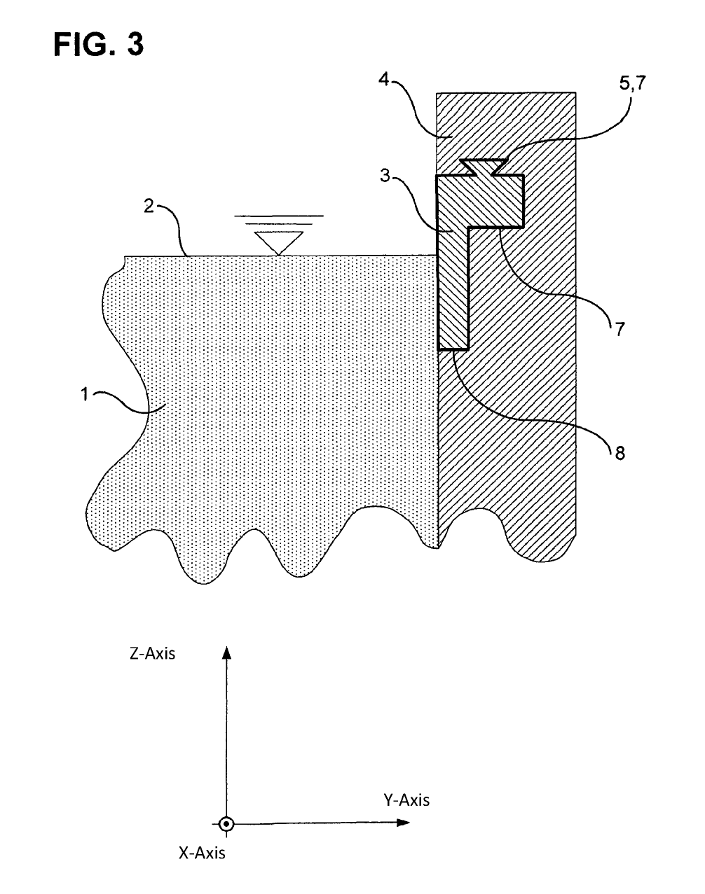

FIG. 3 shows a method and apparatus according to a preferred embodiment of the present invention in a cross section of a portion of a melting furnace or a haulage track with the coordinate system in the Y-axis and the Z-axis, formed such that the main guideway (5) and the main resting surface (7) are combined in one unit, in the shape of a dove tail. The second main resting surface (7) is also arranged above the melt surface (2). In contrast, the secondary resting surface (8) is arranged below the melt surface (2). The melt (1) can enter the secondary resting surface (8) and reduces thereby the durability of the secondary resting surface (8) with respect to the main resting surface (7). The secondary resting surface (8) is thus, in contrast to the main resting surface (7), not in the position to maintain the operability over an extended period in time. It is, of course, also possible to omit a support function or a guiding function, for example by a corresponding arrangement of the centre of mass of the element (3) which is exchangeable during the melting operation, because the melt (1) presses the element (3) which is exchangeable during the melt operation towards the outside towards the carrier element (4) due to the partial pressure of the melt (1).

Within the invention also lie, for example a rotational or increasing or descending movement of the elements (3) which are exchangeable during the melting operation, by which the elements (3) which are exchangeable during the melting operation are only for a certain amount of time in the area of the melting surface (2), as well as below and above the melt surface (2).

In this way, the main guidance (5) and/or the main support surface (7) can also be arranged at least partially below of the melt surface (2).

It is obvious to a person skilled in the art that any technically reasonably shape of the guide or guideways and rest or resting surfaces as well as a combination of guide and rest can be combined in a single unit or in a plurality of units.

A secure sealing of the melt, after the moving of the elements (3) which are exchangeable during the melting operation through the melting furnace and/or the haulage track also has to be ensured. This can be implemented for example by letting the elements (3) which are exchangeable during the melt operation fall or pressing them down in direction of gravity, i.e. a vertical displacement, after the movement through the melting furnace, such that the wear of the element (3) which is exchangeable during the melting operation and the wear of the adjacent elements by the displacement ensures a sealing of the melting furnace or of the haulage track of the melt (1) with the melt (1). A horizontal displacement or a torsion of the element (3) which is exchangeable during the melting operation can also be envisaged for the same purpose.

A corresponding shaping of the element (3) which is exchangeable during the melting operation is considerable.

The carrier element (4) can also have a different width with respect to the element (3) which is exchangeable during the melt operation, by which the number of carrier elements (4) and of the elements (3) which are exchangeable during the melt operation become different with respect to a predetermined length.

A modular design of the elements (3) which are exchangeable during the melting operation, by connectors such as joggling or indenting, connectors of any technical type in lose or tight form, singular or plural, as well as combinations of individual elements (3) that are exchangeable during the melting operation with respect to each other and/or together can be considered as well as the manufacture of an infinite element (3) which is exchangeable during the melting operation, for example by a permanent manufacture in place in a single piece and, for example, termination after the run time of the campaign.

Sealings and/or coatings/revetments of the elements (3) which are exchangeable during the melting operation as well as intermediate elements of same or different materials or types in any variation and arrangement can be considered.

In one type of embodiment in which elements (3) which are exchangeable during the melting operation approach the melt surface (2) from above, run through the melt surface (2) and leave the furnace for example at the bottom of the melt (1), the arrangement of the guideway and/or the support at the side opposite to the melt (1) seems to be the most reasonable. The same holds also for bottom groups which are moved through the bottom.

The application of the force for displacing the elements (3) which are exchangeable during the melting operation with respect to each other, if in one or a plurality of directions is considerable as well, for example guiding tools in any technical type may be required; for example in FIG. 1 to FIG. 3 in the direction of the X-axis. Any of the indicated axes (X-axis, Y-axis, Z-axis) is given for illustrative purposes only and can be turned, twisted, moved, renamed or other.

The individual elements (3) which are exchangeable during the melting operation can be an individual elements, can be composed or joint elements made from a plurality of individual elements, can have multilayer, in different materials, shapes and can have any type and manner known to a person skilled in the art.

Anything explained with respect to the elements (3) which are exchangeable during the melting operation also hold for the carrier element (4).

The present invention is not limited to the melting of glass and the haulage tracks of a glass melt herein but also relate to any type of melt such as for example metals, minerals or mixtures of melts such as to any type of haulage track, haulway or extraction drift of the melt.

### Reference Signs

1 melt
2 melt surface
3 element which is exchangeable during the melting operation
4 support/carrier element
5 main guideway
6 secondary guideway
7 main resting surface
8 secondary resting surface
9 main inflection point
10 secondary inflection point
X-axis axis of the coordinate system
Y-axis axis of the coordinate system
Z-axis axis of the coordinate system

1. A method for melting furnaces in which exchangeable elements which are exchangeable during the melting operation are provided which are arranged in the melting furnace, wherein at least one of a main guide, a resting surface or a combined unit composed of at least one main guide and at least one main resting surface is arranged above the melt surface.

2. The method of claim 1, wherein at least one main inflection point is arranged above the melt surface.

3. An apparatus for melting furnaces in which exchangeable elements which are exchangeable during the melting operation are provided which are arranged in the melting furnace, and which are arranged below of and above of a melt surface, wherein at least one of at least one main guide, at least one main resting surface, or at least one combined unit composed of at least one main guide and at least one main resting surface is provided above the melt surface.

4. The apparatus of claim 3, wherein the apparatus comprises at least one main guide.

5. The apparatus of claim 3, wherein the apparatus comprises at least one main resting surface.

6. The apparatus of claim 3, wherein the apparatus comprises at least one main guide and at least one main resting surface forming one unit.

7. The apparatus of claim 3, further comprising at least one main inflection point forming a unit with at least one of a main guide and a main resting surface.

8. The apparatus of claim 3, wherein the melting furnace is a melting furnace for melting glass.

9. The method of claim 1, wherein the melting furnace is a melting furnace for melting glass.

10. A method for haulage tracks of the melt in which exchangeable elements, which are exchangeable during the melting operation or during the melt flow are provided, which are arranged on the haulage track of the melt, and where at least one of at least one main guide, at least one main resting surface or at least one combined unit composed of at least one main guide and at least one main resting surface is arranged above a melt surface.

11. The method of claim 11, wherein the melting furnace is a melting furnace for melting glass.

12. An apparatus for haulage tracks of the melt in which exchangeable elements which are exchangeable during the melting operation or the melt flow are provided which are arranged on the haulage track of the melt, and which are arranged below as well as above of a melt surface, characterized in that at least one of at least one main guide, at least one main resting surface, or at least a combined unit composed of at least one main guide and at least one main resting surface is provided above the melt surface.

13. The apparatus of claim 13, wherein the melting furnace is a melting furnace for melting glass.
